(19) United States
(12) Patent Application Publication
(10) Pub. No.: US 2022/0387937 A1
(43) Pub. Date: Dec. 8, 2022

(54) SPACER TUBE REVERSE OSMOSIS MEMBRANE AND PREPARATION METHOD THEREOF

(71) Applicant: Jiangsu Longmem Environmental Technology Co., Ltd., Changzhou (CN)

(72) Inventors: Juan Shen, Changzhou (CN); Wei Wang, Changzhou (CN); Yuchen Zhao, Changzhou (CN); Xiaodong Nan, Changzhou (CN)

(73) Assignee: Jiangsu Longmem Environmental Technology Co., Ltd., Changzhou (CN)

(21) Appl. No.: 17/771,822

(22) PCT Filed: Dec. 28, 2021
(86) PCT No.: PCT/CN2021/141959

§ 371 Date: Apr. 26, 2022

(30) Foreign Application Priority Data
Dec. 23, 2021 (CN) 202111587248.9

(51) Int. Cl. B01D 67/00; B01D 61/02; B01D 71/02; B01D 71/68; B01D 61/14; B01D 69/14

(52) U.S. Cl. CPC B01D 67/0079; B01D 61/025; B01D 67/0088; B01D 67/0083; B01D 67/0011; B01D 71/024; B01D 71/68; B01D 61/145; B01D 67/0006; B01D 69/148; B01D 2323/30

(57) ABSTRACT

The present disclosure discloses a spacer tube reverse osmosis (STRO) membrane and a preparation method thereof, which relates to the technical field of reverse osmosis membranes. The preparation method of the STRO membrane specifically comprises the following steps: S101: preparation of a zirconia sol; S102: preparation of a casting solution; S103: preparation of a polysulfone ultrafiltration membrane; S104: immersion; and S105: coating. In the preparation method of the present disclosure, an ionic liquid and high-pressure-resistant particles are introduced into an ultrafiltration layer, the ionic liquid is cross-linked with the ultrafiltration layer in the process of interfacial polymerization, and a layer of the ionic liquid is coated on a surface, so that a three-layer high-performance three-dimensional crosslinking system is formed via the ionic liquid. The ionic liquid is prevented from falling off and dispersing in an oil phase solution, and the pressure resistance and hydrophilic performance of the STRO membrane is greatly improved. The STRO membrane is more suitable for using in high-pressure and high-concentration environments. By combining the ionic liquid with the zirconia sol, the STRO membrane of the present disclosure has higher tensile strength and pressure resistance compared with the reverse osmosis membrane prepared by other modified additives. In addition, the flux and desalination rate of the STRO membrane are also improved compared with the conventional reverse osmosis membranes.

### TECHNICAL FIELD

The present disclosure relates to the technical field of reverse osmosis membranes, and specifically relates to a spacer tube reverse osmosis membrane and a preparation method thereof.

### BACKGROUND ART

Spacer tube reverse osmosis (STRO) membrane is a novel reverse osmosis membrane, widely used in the treatment of raw water with high salinity, high concentration and high pollution due to its high pressure resistance and high pollution resistance.

Currently, the seawater desalination reverse osmosis membrane is mainly adopted as the STRO membrane, which has limited high-pressure resistance and strength during use, and shortened service life. To develop a reverse osmosis membrane dedicated to STRO is currently the main research direction.

As a green solvent and modified catalyst, the ionic liquid has also been used in the preparation of separation membranes. For example, the Chinese patent with the publication number of CN101804304B discloses a method for post-treatment modification of a reverse osmosis membrane, which mainly improves the performance of the reverse osmosis membrane by immersing the reverse osmosis membrane in an ionic liquid. The Chinese patent with the publication number of CN112973463A discloses a method for improving hydrophilic performance of a reverse osmosis membrane by adding an ionic liquid to an oil phase solution.

Although the performance of the reverse osmosis membrane has been improved through the above-mentioned patents, the falling-off problem of the ionic liquid and the dispersion of the ionic liquid in the oil phase solution remain unsolved. Therefore, a STRO membrane and a preparation method thereof are provided by those skilled in the art to solve the above-mentioned problems in the background art.

### SUMMARY

The present disclosure is to provide a STRO membrane and a preparation method thereof, to solve the problems mentioned in the background art.

To achieve the above-mentioned objects, the present disclosure employs the following technical solution: the preparation method of the STRO membrane, which specifically comprises the following steps:

S101: preparation of a zirconia sol: uniformly dispersing ethanol, acetylacetone and zirconium isopropoxide in water to obtain a mixed solution, then stirring the mixed solution at 25° C. to mix evenly, and adjusting a pH value to 1-3 with nitric acid, to obtain the zirconia sol;

S102: preparation of a casting solution: sequentially adding polysulfone particles, polyethylene glycol, the ionic liquid and a coupling agent to dimethylacetamide, and ultrasonically stirring at 60° C. to mix uniformly, then standing for defoaming and cooling, to obtain the casting solution;

S103: preparation of a polysulfone ultrafiltration membrane: slowly pouring the casting solution and the zirconia sol obtained in the above steps into a flat mold which is purpose-made for non-solvent induced phase separation and gel reaction, to obtain the polysulfone ultrafiltration membrane after phase inversion;

S104: immersion: sequentially immersing the polysulfone ultrafiltration membrane in an aqueous phase solution for 30 s and in an oil phase solution, for 60 s, then performing heat treatment at 80° C. for 10 min, to obtain a primary reverse osmosis membrane; and

S105: coating: uniformly coating an aqueous solution containing a coupling, agent KH560 and the ionic liquid on the primary reverse osmosis membrane, and performing the heat treatment at 80° C. for 8 min, to obtain the STRO membrane.

Further, the present disclosure employs the technical solution: in the step S101, a mass ratio of ethanol, acetylacetone and zirconium isopropoxide in the mixed solution is 20%-30% : 1%-5%: 1%-5% of a mass of the mixed solution.

Further, the present disclosure employs the technical solution: in the step S102, a mass percentage of each component in the casting solution is: the polysulfone particles 10 wt %-22 wt %, polyethylene glycol 0.1 wt %-0-2.5 wt %, the ionic liquid 1 wt %-3 wt %, the coupling agent 0.6 wt %-1.5 wt % and dimethylacetamide 73 wt %-88 wt %.

Further, the present disclosure employs the technical solution: the ionic liquid is any one of diisopropylamine 1-alkyl-3-methylimidazolium, 1-butyl-3-methylimidazolium tetrafluoroborate, 1-ethyl-3-methylimidazolium bis(trifluoromethylsulfonyl)imide, 1-octyl-3-methylimidazolium bis(trifluoromethanesulfonyl)imide or 1-butyl-3-methylimidazolium hexafluorophosphate.

Further, the present disclosure employs the technical solution: in the step S102, the coupling agent is any one of A151, KH230, KH-792 or KH560.

Further, the present disclosure employs the technical solution: in the step S104. the aqueous phase solution is composed of the following components: 2 wt % m-phenylenediamine, 0.3 wt % triethylamine, 0.4 wt % camphorsulfonic acid, and a balance of water.

Further, the present disclosure employs the technical solution: in the step S104, the oil phase solution is composed of the following components: 0.07 wt % trimesoyl chloride, 1 wt % the ionic liquid, and a balance of n-hexane solution.

Further, the present disclosure employs the technical solution: in the step S105, the aqueous solution is composed of the following components: 1 wt %-10 wt % the coupling agent KH560, and 2 wt %-10 wt % the ionic liquid.

A STRO membrane is prepared by the preparation method of the STRO membrane.

The present disclosure discloses the STRO membrane and the preparation method thereof. The present disclosure has the following beneficial effects over the prior art:

1. The STRO membrane prepared by the present disclosure forms cross-linking by connecting the zirconia sol with the ionic liquid, and coats a layer of the ionic liquid on the surface of the membrane, so that a three-layer high-performance three-dimensional crosslinking system of the ultrafiltration layer-the interfacial polymerization layer-the post-treatment layer is formed via the ionic liquid. The pressure resistance, strength and hydrophilic performance of the STRO membrane are greatly improved, and the ionic liquid is prevented from falling off. The STRO membrane is more suitable for using in high-pressure and high-concentration environments.

2. By combining the ionic liquid with the zirconia sol, the STRO membrane of the present disclosure is green and pollution-free, and has high catalytic efficiency and good stability over the reverse osmosis membrane prepared by other modified additives.

### DETAILED DESCRIPTION OF THE EMBODIMENTS

The technical solutions in the examples of the present disclosure will be clearly and completely described below in conjunction with the examples of the present disclosure. Obviously, the described examples are only part but not all of the examples of the present disclosure. Based on the examples of the present disclosure, all other examples obtained by those ordinarily skilled in the art without creative efforts shall fall within the protection scope of the present disclosure.

### EXAMPLE 1

The preparation method of the STRO membrane specifically includes the following steps:

S101: Preparation of the zirconia sol: 20 wt % ethanol, 1 wt % acetylacetone and 1 wt % zirconium isopropoxide are unifortnly dispersed in water to stir evenly at 25° C., and the pH value is adjusted to 1 using nitric acid, to obtain the zirconia sol.

S102: Preparation of the casting solution: 10 wt % the polysulfone particles, 0.5 wt % polyethylene glycol, 1 wt % diisopropylamine 1-alkyl-3-methylimidazolium and 0.6 wt % A151 are sequentially added to 87.9 wt % dimethylacetamide to ultrasonically stir at 60° C. to mix uniformly, and then defoaming and cooling are, performed by standing, to obtain the casting solution.

S103: Preparation of the polysulfone ultrafiltration membrane: the casting solution and the zirconia sol obtained in the above steps are slowly poured into the flat mold which is purpose-made for non-solvent induced phase separation and gel reaction, and the polysulfone ultrafiltiation membrane is obtained, after the phase inversion.

S104: Immersion: the polysulfone ultrafiltration membrane is immersed in the aqueous phase solution containing 2 wt % m-phenylenediamine, 0.3 wt % triethylamine and 0.4 wt % camphorsulfonic acid for 30 s, and the excess solution is removed via the rubber roller. Then, the polysulfone ultrafiltration membrane is immersed in the oil phase solution composed of n-hexane solution containing 0.07 wt % trimesoyl chloride and 1 wt % diisopropylamine 1-alkyl-3-methylimidazolium for 60 s, and then the heat treatment is carried out at 80° C for 10 min, to obtain the primary reverse osmosis membrane.

S105: Coating: the aqueous solution containing 1 wt % KH560 and 2 wt % 1-octyl-3-methylimidazolium bis(trifluoromethanesulfonyl)imide is uniformly coated on the primary reverse osmosis membrane, and then the heat treatment is carried out at 80° C. for 8 min. to obtain the STRO membrane.

### EXAMPLE 2

The preparation method of the STRO membrane specifically includes the following steps:

S101: Preparation of the zirconia sol: 20 wt % ethanol, 5 wt % acetylacetone and 5 wt % zirconium isopropoxide are uniformly dispersed in water to stir evenly at 25° C., and the pH value is adjusted to 3 using nitric acid, to obtain the zirconia sol.

S102: Preparation of the casting solution: 10 wt % the polysulfone particles, 0.5 wt % polyethylene glycol, 1 wt % diisopropylamine 1-alkyl-3-methylimidazolium and 0.6 wt % A151 are sequentially added to 87.9 wt % dimethylacetamide to ultrasonically stir at 60° C. to mix uniformly, and then defoaming and cooling are performed by standing, to obtain the casting solution.

S103: Preparation of the polysulfone ultrafiltration membrane: the casting solution and the zirconia sol obtained in the above steps are slowly poured into the flat mold which is purpose-made for non-solvent induced phase separation and gel reaction, and the polysulfone ultrafiltration membrane is obtained after the phase inversion.

S104: Immersion: the polysulfone ultrafiltration membrane is immersed in the aqueous phase solution containing 2 wt % m-phenylenediamine, 0.3 wt % triethylamine and 0.4 wt % camphorsulfonic acid for 30 s, and the excess solution is removed via the rubber roller. Then, the polysulfone ultrafiltration membrane is immersed in the oil phase solution composed of n-hexane solution containing 0.07 wt % trimesoyl chloride and 1 wt % diisopropylamine 1-alkyl-3-methylimidazolium for 60 s, and then the heat treatment is carried out at 80°C. for 10 min, to obtain the primary reverse osmosis membrane.

S105: Coating: the aqueous solution containing 1 wt % KH560 and 2 wt % 1-octyl-3-methylimidazolium bis(trifluoromethanesulfonyl)imide is uniformly coated on the primary reverse osmosis membrane, and then the heat treatment is carried out at 80° C. for 8 min, to obtain the STRO membrane.

### EXAMPLE 3

The preparation method of the STRO membrane specifically includes the following steps:

S101: Preparation of the zirconia sol 20 wt % ethanol, 1 wt % acetylacetone and 1 wt % zirconium isopropoxide are uniformly dispersed in water to stir evenly at 25° C., and the pH value is adjusted to 1 using nitric acid, to obtain the zirconia sol.

S102: Preparation of the casting solution: 22 wt % the polysulfone particles, 0.5 wt % polyethylene glycol, 3 wt % diisopropylamine 1-alkyl-3-methylimidazolium and 1 wt % KH-792 are sequentially added to 73.5 wt % dimethylacetamide to ultrasonically stir at 60° C. to mix uniformly, and then defoaming and cooling are performed by standing, to obtain the casting solution.

S103: Preparation of the polysulfone ultrafiltration membrane: the casting solution and the zirconia sol obtained in the above steps are slowly poured into the flat mold which is purpose-made for non-solvent induced phase separation and gel reaction, and the polysulfone ultrafiltration membrane is obtained after the phase inversion.

S104: Immersion: the polysulfone ultrafiltration membrane is immersed in the aqueous phase solution containing 2 wt % m-phenylenediamine, 0.3 wt % triethylamine and 0.4 wt % camphorsulfonic acid for 30 s, and the excess solution is removed via the rubber roller. Then, the polysulfone ultrafiltration membrane is immersed in the oil phase solution composed of the n-hexane solution containing 0.07 wt % trimesoyl chloride and 1 wt % diisopropylamine 1-alkyl-3-methylimidazolium for 60 s, and then the heat treatment is carried out at 80° C. for 10 min, to obtain the primary reverse osmosis membrane.

S105: Coating: the aqueous solution containing 1 wt % KH560 and 2 wt % 1-octyl-3-methylimidazolium bis(trifluoromethanesulfonyl)imide is uniformly coated on the primary reverse osmosis membrane, and then the heat treatment is carried out at 80° C. for 8 min, to obtain the STRO membrane.

### EXAMPLE 4

The preparation method of the STRO membrane specifically includes the following steps:

S101: Preparation of the zirconia sol: 20 wt % ethanol, 1 wt % acetylacetone and 1 wt % zirconium isopropoxide are uniformly dispersed in water to stir evenly at 25° C., and the pH value is adjusted to 1 using nitric acid, to obtain the zirconia sol.

S102: Preparation of the casting solution: 10 wt % the polysulfone particles, 0.5 wt % polyethylene glycol, 1 wt % diisopropylamine 1-alkyl-3-methylimidazolium and 0.6 wt % A151 are sequentially added to 87.9 wt % dimethylacetamide to ultrasonically stir at 60° C. to mix uniformly, and then defoaming and cooling are performed by standing, to obtain the casting solution.

S103: Preparation of the polysulfone ultrafiltration membrane: the casting solution and the zirconia sol obtained in the above steps are slowly poured into the flat mold which is purpose-made for non-solvent induced phase separation and gel reaction, and the polysulfone ultrafiltration membrane is obtained after the phase inversion.

S104: Immersion: the polysulfone ultrafiltration membrane is immersed in the aqueous phase solution containing 2wt % m-phenylenediamine, 0.3 wt % triethylamine and 0.4 wt % camphorsulfonic acid for 30 s, and the excess solution is removed via the rubber roller. Then, the polysulfone ultrafiltration membrane is immersed in the oil phase solution composed of n-hexane solution containing 0.07 wt % trimesoyl chloride and 1 wt % 1-butyl-3-methylimidazolium tetrafluoroborate for 60 s, and then the heat treatment is carried out at 80° C. for 10 min, to obtain the primary reverse osmosis membrane.

S105: Coating: the aqueous solution containing 5 wt % KH560 and 5 wt % 1-octyl-3-methylimidazolium bis(trifluoromethanesulfonyl)imide is uniformly coated on the primary reverse osmosis membrane, and then the heat treatment is carried out at 80° C. for 8 min, to obtain the STRO membrane.

### EXAMPLE 5

The preparation method of the STRO membrane specifically includes the following steps:

S101: Preparation of the zirconia sol: 20 wt % ethanol, 1 wt % acetylacetone and 1 wt % zirconium isopropoxide are uniformly dispersed in water to stir evenly at 25° C., and the pH value is adjusted to 1 using nitric acid, to obtain the zirconia sol.

S102: Preparation of the casting solution: 10 wt % the polysulfone particles, 0.5 wt % polyethylene glycol, 1 wt % diisopropylamine 1-alkyl-3-methylimidazolium and 0.6 wt % A151 are sequentially added to 87.9 wt % dimethylacetamide to ultrasonically stir at 60° C. to mix uniformly, and then defoaming and cooling are performed by standing, to obtain the casting solution.

S103: Preparation of the polysulfone ultrafiltration membrane: the casting solution and the zirconia sol obtained in the above steps are slowly poured into the flat mold which is purpose-made for non-solvent induced phase separation and gel reaction, and the polysulfone ultrafiltration membrane is obtained after the phase inversion.

S104: Immersion: the polysulfone ultrafiltration membrane is immersed in the aqueous phase solution containing 2 wt % m-phenylenediamine 0.3 wt % triethylamine and 0.4 wt % camphorsulfonic acid for 30 s, and the excess solution is removed via the rubber roller. Then, the polysulfone ultrafiltration membrane is immersed in the oil phase solution composed of n-hexane solution containing 0.07 wt % trimesoyl chloride and 1 wt % 1-butyl-3-methylimidazolium hexafluorophosphate for 60 s, and then the heat treatment is carried out at 80° C. for 10 min, to obtain the primary reverse osmosis membrane.

S105: Coating: the aqueous solution containing 10 wt % KH560 and 10 wt % 1-actyl-3-methylimidazolium bis(trifluoromethanesulfonyl)imide is uniformly coated on the primary reverse osmosis membrane, and then the heat treatment is carried out at 80° C. for 8 min, to obtain the STRO membrane.

### COMPARATIVE EXAMPLE 1

The preparation method of the STRO membrane specifically includes the following steps:

S101: Preparation of the zirconia sol: 20 wt % ethanol, 1 wt % acetylacetone and 1 wt % zirconium isopropoxide are uniformly dispersed in water to stir evenly at 25° C., and the pH value is adjusted to 1 using nitric acid, to obtain the zirconia sol.

S102: Preparation of the casting solution: 10 wt % the polysulfone particles, 0.5 wt % polyethylene glycol, 1 wt % diisopropylamine 1-alkyl-3-methylimidazolium and 0.6 wt % A151 are sequentially added to 87.9 wt % dimethylacetamide to ultrasonically stir at 60° C. to mix uniformly, and then defoaming and cooling are performed by standing, to obtain the casting solution.

S103: Preparation of the polysulfone ultrafiltration membrane: the casting solution and the zirconia sol obtained in the above steps are slowly poured into the flat mold which is purpose-made for non-solvent induced phase separation and gel reaction, and the polysulfone ultrafiltration membrane is obtained after the phase inversion.

S104: Immersion: the polysulfone ultrafiltration membrane is immersed in the aqueous phase solution containing 2 wt % m-phenylenediamine, 0.3 wt % triethylamine and 0.4 wt % camphorsulfonic acid for 30 s, and the excess solution is removed via the rubber roller. Then, the polysulfone ultrafiltration membrane is immersed in the oil phase solution containing 0.07 wt % trimesoyl chloride for 60 s, and then the heat treatment is carried out at 80° C. for 10 min, to obtain the reverse osmosis membrane.

### COMPARATIVE EXAMPLE 2

The preparation method of the STRO membrane specifically includes the following steps:

S101: Preparation of the casting solution: 10 wt % the polysulfone particles, 0.5 wt % polyethylene glycol, 1 wt % diisopropylamine 1-alkyl-3-methylimidazolium and 0.6 wt % A151 are sequentially added to 87.9 wt % dimethylacetamide to ultrasonically stir at 60° C. to mix uniformly, and then defoaming and cooling are performed by standing, to obtain the casting solution.

S102: Preparation of the polysulfone ultrafiltration membrane: the casting solution obtained in the above step is slowly poured into the flat mold which is purpose-made for non-solvent induced phase separation, and the polysulfone ultrafiltration membrane is obtained after the phase inversion.

S103: Immersion: the polysulfone ultrafiltration membrane is immersed in the aqueous phase solution composed of 2 wt % m-phenylenediamine, 0.3 wt % triethylamine and 0.4 wt % camphorsulfonic acid for 30 s, and the excess solution is removed via the rubber roller. Then, the polysulfone ultrafiltration membrane is immersed in the oil phase solution composed of n-hexane solution containing 0.07 wt % trimesoyl chloride for 60 s, and then the heat treatment is carried out at 80° C. for 10 min, to obtain the primary reverse osmosis membrane.

S104: Coating: the aqueous solution containing 1 wt % KH560 and 2 wt % 1-octyl-3-methylimidazolium bis(trifluoromethanesulfonyl)imide is uniformly coated on the primary reverse osmosis membrane, and then the heat treatment is carried out at 80° C. for 8 min, to obtain the STRO membrane.

### EXPERIMENTAL EXAMPLE

The membrane performance testing and characterization of the reverse osmosis membrane prepared in Examples 1-5 and Comparative Examples 1-2 are performed in accordance with GB/T32360-2015 and GB/T30693-2014. The specific experimental results are shown in Table 1 below.

TABLE 1
Testing results of flux, rejection rate and pressure
resistance of the reverse osmosis membrane

| | | NaCL | Pressure | Tensile |
|---|---|---|---|---|
| | Water flux | rejection | resistance | strength |
| Serial No. | (L/m2 · h) | rate (%) | (MPa) | (MPa) |
| Comparative | 34.8 | 77.88 | 2 | 10.77 |
| Example 1 | | | | |
| Comparative | 42.8 | 69.87 | 2.5 | 8.99 |
| Example 2 | | | | |
| Example 1 | 55.7 | 98.55 | 3.8 | 24.12 |
| Example 2 | 53.5 | 99.21 | 4 | 18.77 |
| Example 3 | 56.8 | 97.86 | 4.1 | 16.58 |
| Example 4 | 60.1 | 99.30 | 3.9 | 18.56 |
| Example 5 | 57.5 | 99.16 | 3.8 | 22.55 |

It can be seen from the above experimental results that the reverse osmosis membrane prepared by the preparation method in Examples 1-5 of the present disclosure has excellent water flux and NaCL rejection rate, and the flux has no attenuation after the pressure resistance test is completed. At the same time, the reverse osmosis membrane has excellent mechanical strength due to the high support effect and strength of the ionic liquid and zirconia.

In summary, in the preparation method of the present disclosure, the ionic liquid and the high pressure-resistant particles are introduced into the ultrafiltration layer to form cross-linking in the process of interfacial polymerization, and then a layer of the ionic liquid is coated on the surface, so that a three-layer high-performance three-dimensional crosslinking system is formed via the ionic liquid. The ionic liquid is prevented from falling off and dispersing in the oil phase solution, and the pressure resistance and hydrophilic performance of the reverse osmosis membrane is greatly improved. The reverse osmosis membrane prepared is more suitable for using in high-pressure and high-concentration environments. By combining the ionic liquid with the zirconia sol, the STRO membrane of the present disclosure is green and pollution-free, and has high catalytic efficiency and good stability compared with the reverse osmosis membrane prepared by other modified additives.

For those skilled in the art, it is obvious that the present disclosure is not limited to the details of the above-mentioned examples, but that the present disclosure may be achieved in other specific forms without departing from the spirit or essential characteristics of the present disclosure. Therefore, the examples shall be considered in all respects as illustrative and not restrictive, and the scope of the present disclosure shall be defined by the appended claims rather than the foregoing description. All changes within the meaning and scope of the equivalents falling within the scope of the claims shall be included in the present disclosure.

In addition, it shall be understood that although the description is illustrated via the examples, each example does not only include one independent technical solution. The description is only for clarity, and shall be taken as a whole by those skilled in the art. The technical solutions in each example may also be appropriately combined to form other implementations that can be understood by those skilled in the art.

What is claimed is:

1. A spacer tube reverse osmosis (STRO) membrane, wherein, the STRO membrane is composed of an ultrafiltration layer, an interfacial polymerization layer and a post-treatment layer; the ultrafiltration layer is modified by adding an ionic liquid and high pressure-resistant particles; the interfacial polymerization layer is cross-linked with the ionic liquid of the ultrafiltration layer; the post-treatment layer is coated with a layer of the ionic liquid; and the ultrafiltration layer, the interfacial polymerization layer and the post-treatment layer form a three-layer cross-linking system via the ionic liquid;

2. A preparation method of the STRO membrane, wherein, the preparation method of the STRO membrane specifically comprises the following steps:
S101: preparation of a zirconia sol: uniformly dispersing ethanol, acetylacetone and zirconium isopropoxide in water to obtain a mixed solution, then stirring the mixed solution at 25° C. to mix evenly, and adjusting a pH value to 1-3 with nitric acid, to obtain the zirconia sol;
S102: preparation of a casting solution: sequentially adding polysulfone particles, polyethylene glycol, the ionic liquid and a coupling agent to dimethylacetamide, and ultrasonically stirring at 60° C. to mix uniformly, then standing for defoaming and cooling, to obtain the casting solution;
S103: preparation of a polysulfone ultrafiltration membrane: slowly pouring the casting solution and the zirconia sol obtained in the above steps into a flat mold for non-solvent induced phase separation and gel reaction, to obtain the polysulfone ultrafiltration membrane after phase inversion;
S104: immersion: sequentially immersing the polysulfone ultrafiltration membrane in an aqueous phase solution for 30 s and in an oil phase solution for 60 s, then performing heat treatment at 80° C. for 10 min, to obtain a primary reverse osmosis membrane; and
S105: coating: uniformly coating an aqueous solution containing a coupling agent KH560 and the ionic liquid on the primary reverse osmosis membrane, and performing the heat treatment at 80° C. for 8 min, to obtain the STRO membrane.

3. The preparation method of the STRO membrane according to claim 2, wherein, in the step S101, a mass ratio of ethanol, acetylacetone and zirconium isopropoxide in the mixed solution is 20%-30% : 1%-5% : 1%-5% of a mass of the mixed solution.

4. The preparation method of the STRO membrane according to claim 2, wherein, in the step S102, a mass percentage of each component in the casting solution is: the polysulfone particles 10%-22%, polyethylene glycol 0.1%-2.5%, the ionic liquid 1%-3%, the coupling agent 0.6%-1.5% and dimethylacetamide 73%-88%.

5. The preparation method of the STRO membrane according to claim 2, wherein, the ionic liquid is any one of diisopropylamine 1-alkyl-3-methyliinidazolium, 1-butyl-3-methylimidazolium tetrafluoroborate, 1-ethyl-3-methylimidazolium bis(trifluoromethylsulfonyl)imide, 1-octyl-3-methylimidazolium bis(trifluoromethanesulfonyl)imide or 1-butyl-3-methylimidazolium hexafluorophosphate.

6. The preparation method of the STRO membrane according to claim 2, wherein, in the step S102, the coupling agent is any one of A151, KH230, KH-792 or KH560.

7. The preparation method of the STRO membrane according to claim 2, wherein, in the step S104, the aqueous phase solution is composed of the following components: 2 wt % m-phenylenediamine, 0.3 wt % triethylamine, 0.4 wt % camphorsulfonic acid, and a balance of water as a solvent.

8. The preparation method of the STRO membrane according to claim 2, wherein, in the step S104, the oil phase solution is composed of the following components: 0.07 wt % trimesoyl chloride, 1 wt % the ionic liquid, and a balance of n-hexane as a solvent.

9. The preparation method of the STRO membrane according to claim 2, wherein, in the step S105, the aqueous solution is composed of the following components: 1 wt %-10 wt % the coupling agent KH560, 2 wt %-10 wt % the ionic liquid, and a balance of water.
